(19) United States
(12) Patent Application Publication
(10) Pub. No.: US 2003/0041682 A1
(43) Pub. Date: Mar. 6, 2003

(54) Gear shifting device

(75) Inventor: Martin Koerber, Neufahrn (DE)

Correspondence Address: CROWELL & MORING LLP, INTELLECTUAL PROPERTY GROUP, P.O. BOX 14300, WASHINGTON, DC, 20044-4300, US

(73) Assignee: Bayerische Motoren Werke AG

(21) Appl. No.: 10/215,191

(22) Filed: Aug. 9, 2002

(30) Foreign Application Priority Data
Aug. 10, 2001 (DE) 101 39 512.4

(51) Int. Cl. F16H 59/00; F16H 61/00; F16H 63/00

(52) U.S. Cl. 74/335

(57) ABSTRACT

The gear shifting device contains two adjacent shifting channels, the distance between which is selected such that the exterior circumferences projected in the shifting channel longitudinal direction of the shift sleeves intersect and/or overlap. For this, a circular “recess” is provided in the circumferential area of the one shift sleeve, with which at least a portion of the circumferential area of the other shift sleeve can mesh. The recess can be a circular groove-like indentation for example. The portion of the other shift sleeve meshing with the recess can be a ring-like elevation of complementary design. The width of the groove-like indentation, however, is larger than the width of the ring-like elevation, so that an axial relative displacement of the two shift sleeves is possible.

This application claims the priority of Federal Republic of Germany Patent Document No. 101 39 512.4, filed Aug. 10, 2001, the disclosure of which is expressly incorporated by reference herein.

### BACKGROUND AND SUMMARY OF THE INVENTION

The present invention relates to a gear-shifting device.

DE 39 39 274 C1 discloses a gearbox, in which first and second switchable gearwheels are rotationally mounted on an input shaft. Between the two gearwheels a fixed sleeve is arranged, which is connected torsion-resistantly with the input shaft of the gearbox. On the fixed sleeve, a shift sleeve is arranged in an axially movable manner and can assume three shifting positions, i.e. a center or neutral position and first and second shifting position. The first or the second gearwheel is connected torsion-resistantly with the input shaft via the shift sleeve and the fixed sleeve. For actuating the shift sleeve, a circular groove is provided on the outer circumference of the shift sleeve. The circular groove meshes with a shift fork that is connected with a gearshift bar, wherein the fork can be actuated by the driver via a control lever.

In a speed-change gearbox without planetary wheel sets, such as the one described in DE 39 39 274 C1, a gear is shifted by establishing a positive connection between a gearwheel and the allocated shaft. When the “connection” between the gearwheel and the shaft is closed, torque can be transmitted via this “path”. Such a “connecting element” has an interior part or a fixed sleeve with axially arranged exterior teeth, and an axially displaceable shift sleeve with interior toothing. The fixed sleeve and the shift sleeve are always meshed with each other. Through axial displacement of the shift sleeve, a gearwheel can be shifted, i.e. can be positively connected in the direction of rotation, with the shaft via the fixed sleeve. During displacement from the neutral position, the shift sleeve is moved so far in the axial direction that while it still meshes with the fixed sleeve, the shift sleeve immerses with its interior toothing into the assigned toothing of the component that is to be “coupled”.

In motor vehicle gearboxes, generally several “shifting channels” are arranged next to one another, in each of which a shift sleeve is arranged. The maximum possible diameter of these shift sleeves is limited in conventional gearboxes by the maximum diameter of wheel set components of neighboring shafts or shifting channels and by the distance of the shifting channels.

It is an object of the invention to create a gear-shifting device that has at least two adjacent shifting channels and an even more compact design.

A basic principle of the invention includes selecting the distance of the adjacent shifting channels such that the outer circumferences of the shift sleeves projected in the shifting channel longitudinal direction intersect or overlap. For this purpose, in the circumferential area of the shift sleeve, a circular “recess” is provided, with which at least a portion of the circumferential area of the other shift sleeve can mesh.

The recess can be for example a circular groove-like indentation. The portion of the other shift sleeve meshing with the recess can be ring-like elevation of complementary design. The width of the groove-like indentation, however, is larger by a multiple than the width of the ring-like elevation, so that an axial relative shift of the two shift sleeves, i.e. a shifting of the one shifting channel independent from the other shifting channel, is possible.

In one variation of the invention, both shift sleeves in each case include on their outer circumferential area a circular ring-like elevation which forms an axial “final stop” for the other shift sleeve. This means that the axial displacement path of one shift sleeve is limited in one axial direction by the other shift sleeve, but not in the other axial direction. The ring-like elevations of the two shift sleeves are preferably arranged off-center. In this way, the ring-like elevation of the one shift sleeve is arranged in the vicinity of the front or left axial end of this shift sleeve, and the ring-like elevation of the other shift sleeve is arranged in the vicinity of the rear or right axial end of the other shift sleeve.

Due to the “meshing” configuration or “overlapping” of the two adjacent shift sleeves that are assigned to the shifting channels, with a specified shifting channel distance, the maximum possible diameter of the shift sleeves and thus the maximum possible diameter of allocated synchronizations can be increased. In comparison with a conventional, non-overlapping configuration of the shift sleeves, the diameter can be increased by 10 to 15%, for example. A larger diameter of the synchronizations has the advantage that greater “synchronization performance” can be transmitted, which enables faster shifting.

Other objects, advantages and novel features of the present invention will become apparent from the following detailed description of the invention when considered in conjunction with the accompanying drawings.

### BRIEF DESCRIPTION OF THE DRAWINGS

FIG. 1 shows the configuration of shift sleeves of a gear shifting device based on the state of the art;

FIGS. 2a, b illustrates a first embodiment pursuant to the invention;

FIGS. 3a, b depicts a second embodiment pursuant to the invention;

FIG. 4 represents an embodiment pursuant to FIGS. 2a, b, with shift forks shown additionally.

### DETAILED DESCRIPTION OF THE DRAWINGS

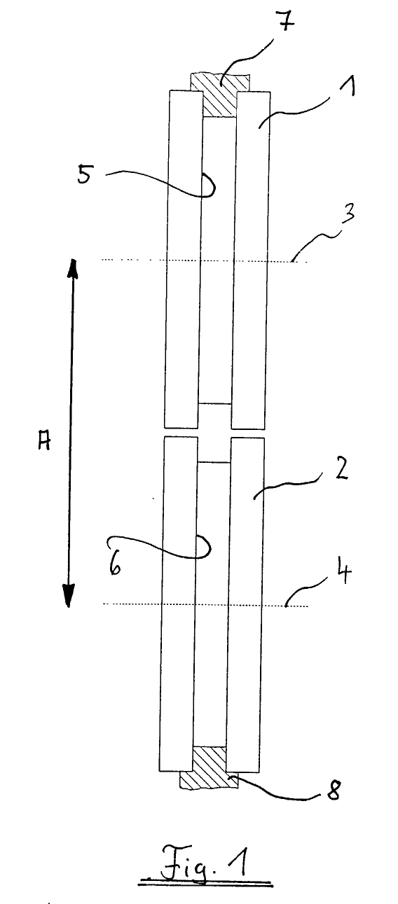

FIG. 1 shows a first shift sleeve 1 and a second shift sleeve 2, which are each allocated to a “shifting channel”, indicated here with dotted lines. The shift sleeves 1, 2 are axially displaceable along the respective shifting channel longitudinal direction 3, 4. For displacing the shift sleeves 1, 2, circular groove-like indentations 5, 6 are provided on their exterior circumference, wherein these indentations mesh with the assigned shift forks 7, 8. The shift forks can be actuated for example with a sliding selector shaft. Alternative to a shift fork, a rocker arm can also be provided.

In the gear shifting device shown in FIG. 1, the reduction of the distance A between the two shifting channels is limited by the diameter of the sleeves 1, 2. Alternatively, or with a specified shifting channel distance A, the diameters of the sleeves 1, 2 are limited because at least a small distance must be provided between their exterior circumference.

FIG. 2a shows an embodiment where a circular ring-like elevation 9 is provided preferably in the center on the exterior circumference of the shift sleeve 1. The shift sleeve 2 includes a circular groove-like indentation 6, similar to FIG. 1. The shift sleeves 1, 2 are dimensioned and arranged here such that the ring-like elevations 9 of the shift sleeve 1 “meshes” with the groove-like indentation 6 of the shift sleeve 2. The axial projections of the shift sleeves 1, 2 therefore overlap.

As distinct from the state of the art shown in FIG. 1, with a specified shifting channel distance A, the maximum outer diameter of the shift sleeve 1 and thus the maximum possible diameter of a synchronous ring that is allocated to the shift sleeve 1 can be constructed larger.

The width B of the groove-like indentation 6 of the shift sleeve 2 here is larger by a multiple than the width b of the ring-like elevation 9 of the shift sleeve 1. This enables an axial relative shift of the shift sleeve 1 in relation to the shift sleeve 2, which is depicted in FIG. 2b. The shifting channel that is allocated to the shift sleeve 1 can thus be shifted with the “displacement width B” independently from the shifting state of the shift sleeve 2.

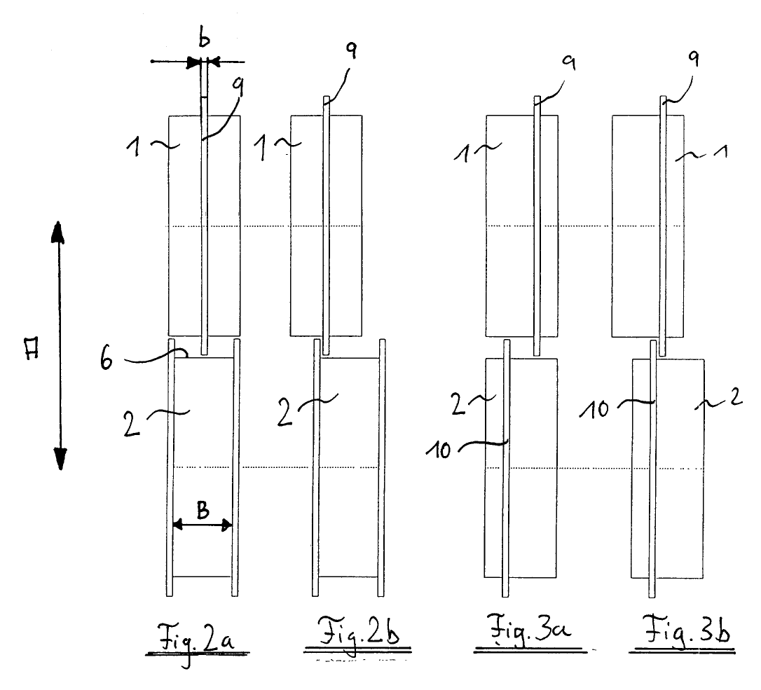

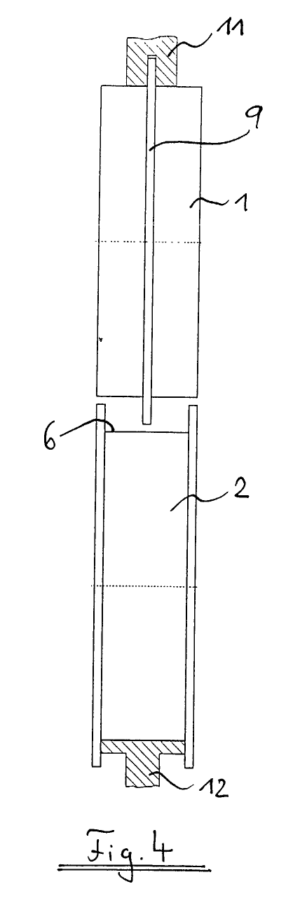

FIGS. 3a and 3b show an embodiment where on both shift sleeves 1, 2, a circular ring-like elevation 9, 10 is provided in each case. The ring-like elevation 9 of the shift sleeve 1 is offset “to the right” in relation to the center plane of the shift sleeve 1, i.e. is arranged off-center. In contrast, the ring-like elevation 10 of the shift sleeve 2 is offset “to the left” in relation to the center plane of the shift sleeve 2.

While in the embodiment in FIGS. 2a, 2b the maximum possible displacement path is limited in both directions, in the embodiment in FIGS. 3a and 3b, the displacement path of the shift sleeve 1 or 2 is limited in any given case only in one direction by the other shift sleeve 1 or 2. This means that the ring-like elevations 9, 10 of the shift sleeves 1, 2 at all times form an “end stop” for the other shift sleeve. Since, however, here as well the shift sleeves 1, 2 “mesh with each other”, i.e. overlap, with their ring-like elevations 9, 10, larger shift sleeve diameters and/or larger synchronous ring diameters compared to the state of the art can be achieved.

FIG. 4 shows an embodiment in accordance with FIGS. 2a, 2b. However here additional “displacement elements” are shown for the purpose of displacing the shift sleeves 1, 2. The displacement element for the shift sleeve 1 is a clamp-like, slotted shift fork 11, which covers the ring-like elevation 9. The displacement element for the shift sleeve 2, on the other hand, is a conventional shift fork and/or a conventional rocker arm 12, which meshes with the groove-like indentation 6. The clamp-like shift fork 11 and the shift fork 12 can be connected with a gearshift bar in the conventional manner.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. Gear shifting device with two adjacent shifting channels, to which in any given case a shift sleeve that is displaceable in the shifting channel longitudinal direction is assigned, wherein the shift sleeves are arranged such that their exterior circumferences, which are projected in the shifting channel longitudinal direction, overlap.

2. Gear shifting device pursuant to claim 1, wherein in the circumferential area of the one shift sleeve, a recess is provided with which at least a portion of the circumferential area of the other shift sleeve can mesh.

3. Gear shifting device pursuant to claim 2, wherein the recess is a circular groove indentation and the portion of the circumferential area of the other shift sleeve meshing with it is a circular ring elevation.

4. Gear shifting device pursuant to claim 3, wherein the axial width of the groove indentation is larger by a multiple than the axial width of the ring elevation.

5. Gear shifting device pursuant to claim 3, wherein the width of the groove indentation of the one shift sleeve is larger by at least the shifting path of the other shift sleeve than the width of the ring elevation.

6. Gear shifting device pursuant to claim 1, wherein both shift sleeves on their exterior circumference contain a circular ring elevation, respectively.

7. Gear shifting device pursuant to claim 6, wherein at least one of the ring elevations are arranged in an offset manner with regard to the center plane of the allocated shift sleeve.

8. Gear shifting device pursuant to claim 7, wherein the ring elevation of the one shift sleeve is arranged in the vicinity of the front end of the one shift sleeve with regard to an axial direction, and the ring elevation of the other shift sleeve is arranged in the vicinity of the rear end of the other shift sleeve with regard to the axial direction.

9. A gear shifting device comprising parallelly arranged first and second shifting channels, and first and second shift sleeves that are displaceable, respectively, in the first and second shifting channels in the longitudinal direction of the shifting channels, wherein circumferential areas of the shift sleeves overlap in the radial direction.

10. The gear shifting device of claim 9, wherein the circumferential area of the first shift sleeve includes a recess which meshes with the circumferential area of the second shift sleeve.

11. The gear shifting device of claim 11, wherein the recess is a circular groove indentation, and wherein the circumferential area of the second shift sleeve includes a circular ring elevation that meshes with the circular groove indentation of the first shift sleeve.

12. The gear shifting device of claim 11, wherein an axial width of the groove indentation of the first shift sleeve is larger by a multiple than an axial width of the ring elevation of the second shift sleeve.

13. The gear shifting device of claim 12, wherein the width of the groove indentation of the first shift sleeve is larger by at least the shifting path of the second shift sleeve than the width of the ring elevation.

14. The gear shifting device of claim 11, wherein the width of the groove indentation of the first shift sleeve is larger by at least the shifting path of the second shift sleeve than the width of the ring elevation.

15. The gear shifting device of claim 10, wherein the circumferential area of each of the shift sleeves includes a circular ring elevation.

16. The gear shifting device of claim 9, wherein the circumferential area of each of the shift sleeves includes a circular ring elevation.

17. The gear shifting device of claim 16, wherein at least one of the ring elevations is offset with regard to a center plane of the shift sleeve on which this ring elevation is disposed.

18. The gear shifting device of claim 17, wherein the ring elevation of the first shift sleeve is arranged near a front end of the first shift sleeve, and the ring elevation of the second shift sleeve is arranged near a rear end of the second shift sleeve.

19. A method of making a gear shifting device that includes parallelly arranged first and second shifting channels, and first and second shift sleeves that are displaceable, respectively, in the first and second shifting channels in the longitudinal direction of the shifting channels, the method comprising arranging the circumferential areas of the shift sleeves in an overlapping manner in the radial direction.

20. The method of claim 19, further comprising placing a circular groove indentation on the circumferential area of the first shift sleeve, and placing a circular ring elevation the circumferential area of the second shift sleeve, wherein the circular groove indentation and circular ring elevation mesh with each other.

21. The method of claim 19, further comprising a circular ring elevation in the circumferential area of each of the shift sleeves includes, wherein at least one of the ring elevations is offset with regard to a center plane of the shift sleeve on which this ring elevation is disposed.
